(19) United States
(12) Patent Application Publication
(10) Pub. No.: US 2011/0179650 A1
(43) Pub. Date: Jul. 28, 2011

(54) Pill Card Bubble Cutter

(76) Inventor: William Farrell, Lakewood, CA (US)

(21) Appl. No.: 13/011,314

(22) Filed: Jan. 21, 2011

Related U.S. Application Data
(60) Provisional application No. 61/298,064, filed on Jan. 25, 2010.

(51) Int. Cl. B26B 17/00

(52) U.S. Cl. 30/175

(57) ABSTRACT

A pill card bubble cutter includes a hinged or sliding “clam shell” like hand held cutter with opposing blades along one side for cutting through the pill card bubbles to release pills, and resembles a common staple puller. The cutter may further include a cup or pouch to catch the pill once released. In another embodiment, the cutter has a single blade opposing a stop to cut through one side of the bubble to allow the bubble to be bent back to release the pill. The cutter may alternatively include two opposing parallel sides pressed together to cut through the bubble.

The present application claims the priority of U.S. Provisional Patent Application Ser. No. 61/298,064 filed Jan. 25, 2010, which application is incorporated in its entirety herein by reference

### BACKGROUND OF THE INVENTION

The present invention relates to access to pills and in particular to a simple to use cutter for cutting through bubbles on pill cards to release the pills.

Older people often take medication in the form of pills packaged in pill cards. The pills are carried between the card and a clear plastic bubble. Unfortunately, these older people have difficulty in releasing the pills, and often lose the pills upon release.

### BRIEF SUMMARY OF THE INVENTION

The present invention addresses the above and other needs by providing a pill card bubble cutter which includes a hinged or sliding “clam shell” like hand held cutter with opposing blades along one side for cutting through the pill card bubbles to release pills, and resembles a common staple puller. The cutter may further include a cup or pouch to catch the pill once released. In another embodiment, the cutter has a single blade opposing a stop to cut through one side of the bubble to allow the bubble to be bent back to release the pill. The cutter may alternatively include two opposing parallel sides pressed together to cut through the bubble.

In accordance with one aspect of the invention, there is provided a pill card bubble cutter including a right half, a left half moveably connected to the right half, and at least one horizontal blade at a base of one of the halves. The blade has a sharp edges facing an opposing one of the halves and pressing the halves together moves the blade closer to the opposing half.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A shows a pill card bubble cutter 10 according to the present invention preparing to cut through a bubble in a pill card.

FIG. 1B shows the pill card bubble cutter according to the present invention cutting through the bubble in the pill card

FIG. 2A is a side view of the pill card bubble cutter according to the present invention.

FIG. 2B is an end view of the pill card bubble cutter according to the present invention.

FIG. 2C is a top view of the pill card bubble cutter according to the present invention.

FIG. 2D is a bottom view of the pill card bubble cutter according to the present invention.

FIG. 3 is a cross-sectional view of the pill card bubble cutter according to the present invention.

FIG. 4 is a first alternative pill card bubble cutter according to the present invention having a single blade and an opposing block.

FIG. 5 is a second alternative pill card bubble cutter according to the present invention having parallel opposing side pressed together.

FIG. 6A is a side view of a third alternative pill card bubble cutter according to the present invention having enclosed blades.

FIG. 6B is an end view of the third alternative pill card bubble cutter according to the present invention having enclosed blades.

FIG. 7 is a cross-sectional view of the third alternative pill card bubble cutter according to the present invention having enclosed blades taken along line 7-7 of FIG. 6B.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

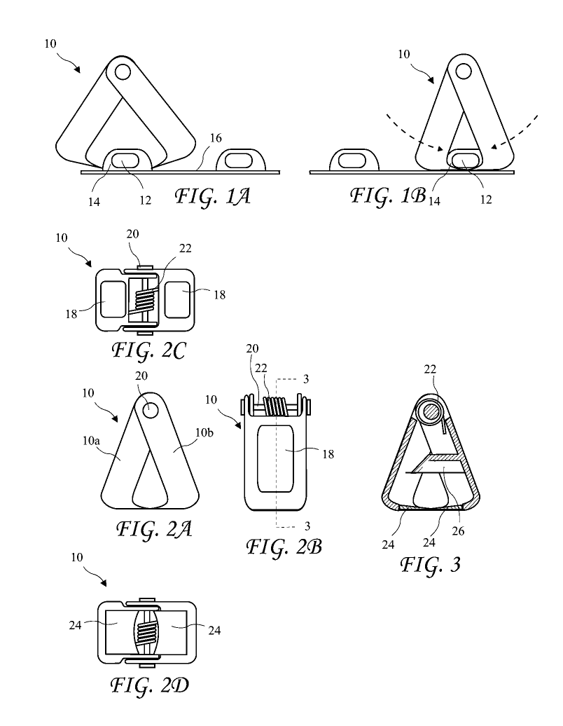

A pill card bubble cutter 10 according to the present invention is shown preparing to cut through a bubble 14 of a pill card 16 in FIG. 1A, and another pill card bubble cutter 10 is shown cutting through another bubble 14 in FIG. 1B. The pill card bubble cutter 10 is squeezed together by a user to cut through the bubble 14 to release the pull 12.

A side view of the pill card bubble cutter 10 according to the present invention is shown in FIG. 2A, an end view of the pill card bubble cutter 10 is shown in FIG. 2B, a top view of the pill card bubble cutter 10 is shown in FIG. 2C and a bottom view of the pill card bubble cutter 10 is shown in FIG. 2D. The pill card bubble cutter 10 includes two halves 10a and 10b which are squeezed together to use the cutter. Each half 10a and 10b preferably includes an indentation 18 for easier use. The cutter 10 is hinged by a pin 20 passing through both sides 10a and 10b and a spring 22 biases the cutter 10 to an open position. Opposing blades 24 at the bottom of the cutter 10 cut through the bubble 14 when the cutter is positioned on the bubble and squeezed.

A cross-sectional view of the pill card bubble cutter 10 taken along line 3-3 of FIG. 2B is shown in FIG. 3. A cup 26 is formed inside the cutter 10 to catch the pill 12 after cutting through the bubble 14. The cup 26 mal also be a net like structure, or any structure suitable for catching the pill 12, and the cup 26 may be molded as part of one of the cutter halves, or be glued or snapped into place after molding the cutter half.

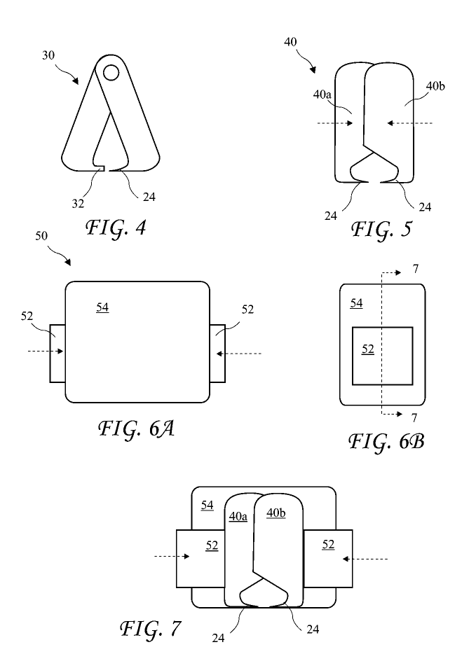

A first alternative pill card bubble cutter 30 according to the present invention having a single blade 24 and an opposing block 32 is shown in FIG. 4. The cutter 30 allows a user to cut partly through the bubble 14 and fold the bubble back to access the pill 12

A second alternative pill card bubble cutter 40 according to the present invention having parallel opposing press together sides is shown in FIG. 5. The cutter 40 includes sides 40a and 40b which are connected to hold the sides parallel which allowing squeezing the sides together. A spring captured between the sides biases the sides apart.

A side view of a third alternative pill card bubble cutter 55 according to the present invention having enclosed blades is shown in FIG. 6A, an end view of the third alternative pill card bubble cutter 50 is shown in FIG. 6B, and a cross-sectional view of the third alternative pill card bubble cutter 50 taken along line 7-7 of FIG. 6B, is shown in FIG. 7. The pill card bubble cutter 55 includes a housing 54 surrounding the blades 24 to help prevent cutting a user's fingers. Plungers 52 on opposite ends of the housing 54 press the cutters 24 together to cut through the bubble 14 to release the pill 12 (see FIG. 1B).

While the invention herein disclosed has been described by means of specific embodiments and applications thereof, numerous modifications and variations could be made thereto by those skilled in the art without departing from the scope of the invention set forth in the claims.

I claim:

1. A pill card bubble cutter comprising:
a right side;
a left side moveably connected to the right side; and
at least one horizontal blade at a base of one of the sides, the blades having a sharp edges facing an opposing one of the sides, wherein pressing the sides together moves the blade closer to the opposing side.

2. The cutter of claim 1, wherein the at least one horizontal blade comprises two opposing blades.

3. The cutter of claim 1, wherein the at least one horizontal blade comprises one horizontal blade opposing a block.

4. The cutter of claim 1, wherein the sides are pivotally connected by a pin.

5. The cutter of claim 4, wherein the a coil spring resides over the pin to bias the cutter to an open position.

6. The cutter of claim 4, wherein the a spring resides between the cutter sides to bias the cutter to an open position.

7. The cutter of claim 4, wherein the sides and blades reside in a housing guarding the blades for helping prevent cutting a user's fingers.

8. The cutter of claim 7, wherein opposing plungers reach through opposing ends of the housing and press against the sides of the cutter to operate the cutter.

9. The cutter of claim 1, wherein the cutter comprises sides slideably cooperating to operate the cutter.

10. The cutter of claim 9, wherein the sides and blades reside in a housing guarding the blades for to helping prevent cutting a user's fingers.

11. The cutter of claim 10, wherein opposing plungers reach through opposing ends of the housing and press against the sides of the cutter to operate the cutter.

12. A pill card bubble cutter comprising:
a right side;
a left side moveably connected to the right side;
opposing horizontal blades at bases of each of the sides, the blades having sharp edges facing an opposing one of the sides, wherein pressing the sides together moves the blade closer to the opposing side; and
a spring biasing the sides apart.

13. A pill card bubble cutter comprising:
a housing;
a right side residing in the housing;
a left side residing in the housing and moveably connected to the right side;
opposing horizontal blades attached to bases of each of the sides and residing in the housing, the housing guarding the blades for helping prevent cutting a user's fingers, the blades having sharp horizontal opposing edges facing inward, wherein pressing the sides together moves the blades together;
a spring biasing the sides apart; and
opposing plungers reaching through opposing ends of the housing and pressing against the sides of the cutter to operate the cutter.
